(19) United States
(12) Patent Application Publication
(10) Pub. No.: US 2010/0287513 A1
(43) Pub. Date: Nov. 11, 2010

(54) MULTI-DEVICE GESTURE INTERACTIVITY

(75) Inventors: Karan Singh, Seattle, WA (US); Bogdan Popp, Sammamish, WA (US); Douglas Kramer, Bothell, WA (US); Dalen Mathew Abraham, Duvall, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/435,548

(22) Filed: May 5, 2009

(51) Int. Cl. G06F 3/033

(52) U.S. Cl. 715/863

(57) ABSTRACT

A system is provided for enabling cross-device gesture-based interactivity. The system includes a first computing device with a first display operative to display an image item, and a second computing device with a second display. The second display is operative to display a corresponding representation of the image item in response to a gesture which is applied to one of the computing devices and spatially interpreted based on a relative position of the first computing device and the second computing device.

### BACKGROUND

Computing devices are growing ever more sophisticated in providing input and output mechanisms that enhance the user experience. It is now common, for example, for a computing device to be provided with a touchscreen display that can provide user control over the device based on natural gestures applied to the screen. Regardless of the particular input and output mechanisms employed, a wide range of considerations may need to be balanced to provide an intuitive user experience. Increasingly, end users want to interact in close-proximity settings where multiple devices and users participate in the interaction. While the presence of multiple devices can increase the potential for interaction, it can also complicate the ability to provide an intuitive interactive user experience.

### SUMMARY

Accordingly, the present description provides a system for providing cross-device gesture-based interactivity between a first computing device and a second computing device. At the first computing device, a digital media item or other image item is displayed. A spatial module is provided on at least one of the devices to receive a spatial context based on a relative position of the devices. A gesture interpretation module is provided on at least one of the devices, and is operable to receive a gesture input in response to a gesture applied at one of the devices. The gesture interpretation module provides a cross-device command which is wirelessly communicated between the devices and dependent upon the gesture input and the spatial context. In response to the cross-device command, the display of a corresponding representation of the image item is controlled at the second computing device.

The above Summary is provided to introduce a selection of concepts in a simplified form that are further described below in the Detailed Description. This Summary is not intended to identify key features or essential features of the claimed subject matter, nor is it intended to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic depiction of an exemplary system for providing cross-device gesture-based interactivity.

FIG. 2 is a schematic depiction of a portable computing device and a table-type computing device configured to provide cross-device gesture-based interactivity.

FIGS. 3-6 provide examples of gestures that may be employed with the exemplary devices of FIG. 1 and FIG. 2.

FIG. 7 depicts an example of controlling display of corresponding image items on interacting devices in response to an exemplary joining gesture, and in response to an overlay orientation of the display screens of the interacting devices.

FIG. 8 depicts an example of using a touch gesture at one device to initiate image transfer and control display of a corresponding image item at a second device.

FIG. 9 depicts an example of controlling output on a display in response to a combined interpretation of gestures occurring at separate devices.

FIG. 10 depicts an exemplary method for providing cross-device gesture-based interaction.

### DETAILED DESCRIPTION

The present description addresses systems and methods for providing gesture-based and/or gesture-initiated interactivity across multiple devices. Typically, two or more computing devices are present in the same physical space (e.g., in the same room), so as to allow users to interact with each other and the devices. Often, gestures made at one device create a visual output or result at another of the devices, and it can be beneficial for the user or users to see the interactions and output occurring at each device. Accordingly, many of the examples herein involve a spatial setting in which the users and computing devices are all close together with wireless communication employed to handle various interactions between the devices.

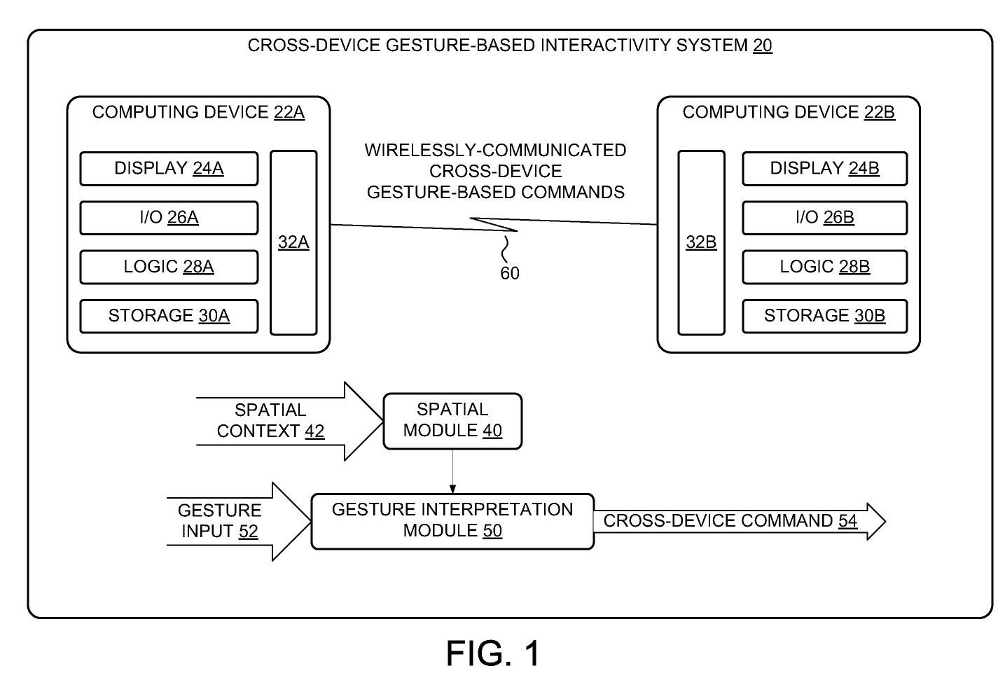

FIG. 1 schematically depicts a system 20 for providing cross-device gesture-based interactivity. The system includes a first computing device 22a, including a display subsystem 24a, I/O subsystem 26a, logic subsystem 28a and storage subsystem 30a. Display subsystem 24a includes a display to provide visual output and otherwise display representations of data in storage subsystem 30a. I/O subsystem 26a provides input and output functionality, for example to drive output to a display screen or receive user inputs (e.g., from a keyboard, keypad, mouse, microphone, touchscreen display, etc.). Logic subsystem 28a, which may include one or more processors, provides processing operations and executes instructions residing in storage subsystem 30a. In particular, logic subsystem 28a may interact with applications and other data on storage subsystem 30a to carry out the cross-device gesture interactivity described herein.

As indicated, system 20 also includes a second computing device 22b. Computing device 22b may be in wireless communication with device 22a, and includes components corresponding to those of computing device 22a (corresponding components are designated with the same reference number but with the suffix “b”). Storage subsystem 30a and storage subsystem 30b typically include modules and other data to support the wireless gesture-based interaction between computing device 22a and computing device 22b.

As shown in the figure, system 20 may further include a spatial module 40 operative to receive a spatial context 42 which is based on a relative position of computing device 22a and computing device 22b. One or both of the depicted computing devices may be provided with a spatial module such as spatial module 40.

Depending on the particular configuration of the computing devices, spatial context 42 can reflect and/or vary in response to (1) a distance between computing device 22a and computing device 22b; (2) relative motion occurring between the devices; and/or (3) a relative orientation (e.g., rotational position) of the devices. These are but examples; further possibilities exist. Furthermore, the spatial context can also include, or be used to determine, similar information with respect to items displayed on the devices. For example, if an image item is moving leftward across a display screen on one device, knowledge of the relative location of the devices can allow determination of how that image item is moving with respect to the other device, and/or with respect to items displayed on the other device.

Continuing with FIG. 1, system 20 also includes a gesture interpretation module 50, which is operative to receive a gesture input 52 and output a cross-device command 54. One or both of the depicted computing devices may include a gesture interpretation module. Gesture input 52 is based on a user gesture which can be applied at either or both of the computing devices. Cross-device command 54 is communicated wirelessly between the devices, for example via wireless link 60. Cross-device command 54 is dependent upon spatial context 42 and gesture input 52, and may be a display command operable to cause or control display of content at display 24a and/or display 24b. In one example, an image item is displayed on one of the displays, and the cross-device gesture command controls display of a corresponding representation of that image item on the other display. A more specific version of this example involves a transfer of a digital photo or other digital media item from one device to the other in response to a gesture applied at one of the devices.

One or more of the devices participating in cross-device gesture interactivity may include a wireless communication/data transfer module to support the interaction. In FIG. 1, for example both devices include such a module: wireless communication/data transfer module 32a and wireless communication/data transfer module 32b. In many cases, a cross-device gesture interaction will include transfer of underlying data from one device to another. Modules 32a and 32b may be configured to handle such a transfer, for example the transfer of a digital photograph as initiated by a gesture applied at one of the devices. In addition to transferring data payloads, such a module may be employed to wirelessly communicate gesture commands, metadata pertaining to device interactions, etc. Generally, a wireless communication/data transfer modules is configured to interact with and collect information from any combination of the depicted I/O, logic and storage modules, and then communicate with a similar wireless communication/data transfer module on another device.

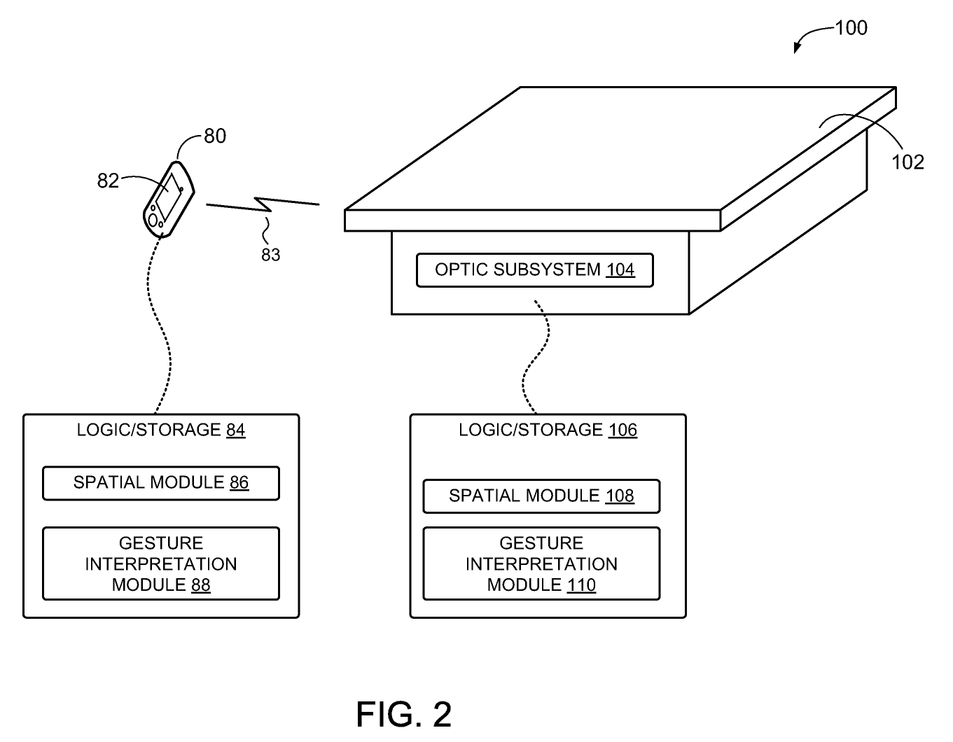

FIG. 2 depicts two example computing devices which may be used in a cross-device gesture-based interactivity system such as that described with FIG. 1. In particular, the figure depicts a portable computing device 80, which may include components similar to those described with respect to the schematically-depicted computing devices of FIG. 1. Specifically shown in FIG. 2 is a display screen 82 and logic/storage subsystem 84, which may include a spatial module 86 and a gesture interpretation module 88, similar to the previously-described spatial module and gesture module.

Portable computing device 80 is in wireless communication via wireless link 83 with a table-type computing device 100, which has a large-format horizontally-oriented display 102. In addition to providing display output, display 102 may be touch interactive, so as to receive and be responsive to touchscreen inputs. Touch and other input functionality may be provided via operation of an optic subsystem 104 located beneath the surface of display 102. The figure also depicts a logic/storage subsystem 106 of device 100, which may also include a spatial module 108 and a gesture interpretation module 110 similar to those described with reference to FIG. 1. As will be described in further detail, the gesture interpretation and spatial modules of FIG. 2 may be configured to interact, via wireless communication between device 80 and device 100, so as to provide cross-device gesture-based interaction.

To provide display functionality, optic subsystem 104 may be configured to project or otherwise produce a visible image onto the touch-interactive display surface of display 102. To provide input functionality, the optic subsystem may be configured to capture at least a partial image of objects placed on the touch-sensitive display surface—fingers, electronic devices, paper cards, food, or beverages, for example. Accordingly, the optic system may be configured to illuminate such objects and to detect the light reflected from the objects. In this manner, the optical system may register the position, footprint, and other properties of any suitable object placed on the touch-sensitive display surface. Optic functionality may be provided by backlights, imaging optics, light valves, diffusers and the like.

Optic subsystem 104 can also be used to obtain the relative position of portable computing device 80 and table-type computing device 100. Thus, spatial information such as spatial context 42 (FIG. 1) may be obtained via operation of optic subsystem 104. This spatial information can be provided to spatial module 108 for use in interpretation of gestures made at either or both of the devices depicted in FIG. 2. For example, if portable computing device 80 is placed on the surface of display 102, the optic subsystem 104 can optically recognize device 80 (e.g., via footprint recognition) and discern its orientation, which can then be reported to spatial module 108.

It should be understood spatial information and/or gesture recognition may be obtained in various ways in addition to or instead of optical determination, including through RF transmission, motion/position sensing using GPS, capacitance, accelerometers, etc., and/or other mechanisms. An accelerometer can be used, for example, to detect and/or spatially interpret a shaking gesture, in which a user shakes a portable device as part of a cross-device interaction. Also, handshaking or other communication mechanisms may be employed in order to perform device identification and facilitate communication between devices supporting cross-device gesturing.

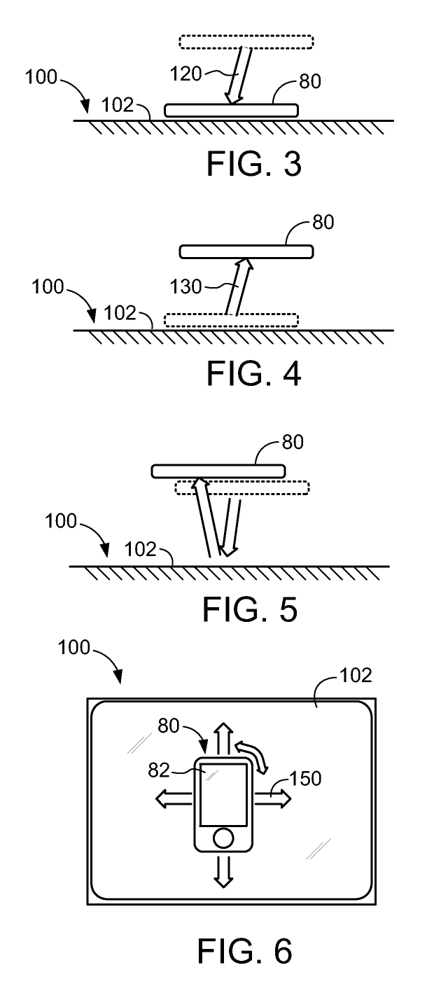

FIGS. 3-6 depict examples of gestures involving portable computing device 80 and an interactive display system, such as table-type computing device 100. The particular devices are used only for purposes of illustration, and it should be understood that the exemplary gestures can applied to interactive display systems and/or other types of devices and systems, including mobile phones, desktop computers, laptop computers, personal digital assistants, etc. The example gestures of these figures involve a relative motion occurring between the devices. Optic subsystem 104 (FIG. 2) may detect this motion and communicate with spatial module 108 to provide spatial information (e.g., the spatial context 42 of FIG. 1) that can be used by gesture interpretation modules at device 80 and/or device 100. In some examples, the spatial context will be shared between spatial module 108 and spatial module 86 (FIG. 2), to facilitate gesture interpretation at each device.

The exemplary gestures of FIGS. 3-5 show device 80 moved from an initial position (dashed lines) to an ending position (solid lines). FIG. 3 shows an example of a joining gesture 120, in which device 80 and device 100 are brought together in close proximity (e.g., contact or near-contact). More particularly, device 80 is placed onto the surface of display 102 in the example gesture. FIG. 4 depicts an example of a separating gesture 130, in which device 80 and device 100 are separated from a state of being in close proximity. Specifically, the example shows a gesture in which device 80 is withdrawn from being in contact with display 102. FIG. 5 shows an example of a stamping gesture 140, in which device 80 and display 102 are brought together and then separated from a state of being in close proximity to one another.

FIG. 6 shows an example of a sliding overlay gesture 150. In this example, device 80 has been placed on the surface of display 102. Generally, this orientation of the devices may be referred to as an overlay orientation, because display screen 82 of portable computing device 80 overlays display 102 of table-type computing device 100. As will be explained further, the overlay orientation of the displays can offer many opportunities for cross-device interaction, including interactions based on gestures and/or spatial information, such as spatial information derived through operation of optic subsystem 104 (FIG. 2). As can be seen in FIG. 6, sliding overlay gesture 150 involves a change in relative position of devices 80 and 100 while maintaining the respective displays in an overlay orientation. The sliding overlay gesture can involve relative translation and rotation in any suitable direction, as indicated by the various arrows in the figure.

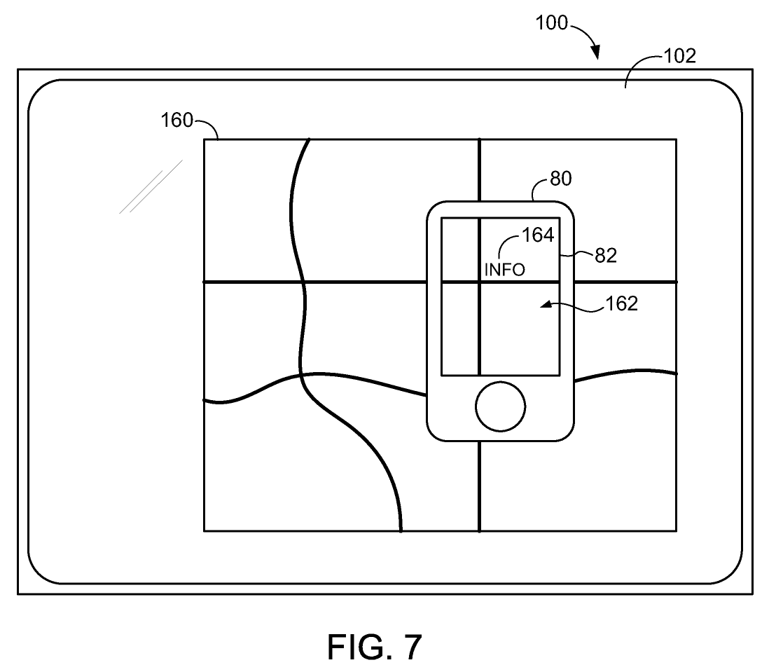

FIG. 7 provides a further example of cross-device gesture-based interaction occurring between portable computing device 80 and table-type computing device 100. In this example, an image item in the form of a map 160 is displayed on display 102. Device 80 has been placed on display 102 using a joining gesture, such that the respective displays 82 and 102 of the devices are in an overlay orientation. The joining gesture may be detected via operation of optic subsystem 104 (FIG. 2), for example by optically detecting the bringing of device 80 into contact with display 102. Furthermore, the optic subsystem may generate spatial information, such as the spatial context 42 of FIG. 1, which operates to provide information about the particular location and rotational orientation of device 80 on the surface of display 102. The spatial information and gesture detection may be received and processed by spatial module 108 and gesture interpretation module 110 of device 100 (FIG. 2).

Continuing with FIG. 7, based on detection of the joining gesture and the spatial context, a cross-device command may be wirelessly communicated between the devices. In the present example, the cross-device command has caused display screen 82 to display a corresponding overlay representation 162 of map 160. The spatial information has been used in this example to cause the portion of the map directly underneath device 80 to be displayed on display screen 82. Furthermore, if device 80 is moved via a sliding gesture such as shown in FIG. 6, a cross-device command would issue to modify the overlay representation on display screen 82. Also, as shown in the figure, the overlay representation may include additional information 164 not displayed on the version on display 102.

As in the example of FIG. 7, the cross-device gesture-based interactions described herein will often involve an image item displayed at a first device, and controlling display by a second device of a corresponding representation of that image item. More generally, display output at one device may be controlled by spatially-interpreted gestures occurring at a second device. Controlling display at the second device can include displaying or not displaying the output (e.g., a corresponding representation of an image item), causing output on the second device to occur at a particular location on the display of the second device, and/or controlling characteristics of an overlay representation, to name but a few examples. When multiple interacting devices display corresponding representations (e.g., of a photograph), the interpreted gestures may also be used to initiate wireless transmission of the underlying data from device to device.

As indicated above, controlling a corresponding representation of an image item can include transferring the image item from one device to the other and displaying the corresponding representation on the display of the target device. The various example gestures of FIGS. 3-5 may be used to perform such an action, for example to cause a photograph on one display to be displayed on the other display. In particular, an image displayed on device 80 can be displayed on device 100 (or vice versa) in response to a joining gesture (FIG. 3), separating gesture (FIG. 4) or stamping gesture (FIG. 5).

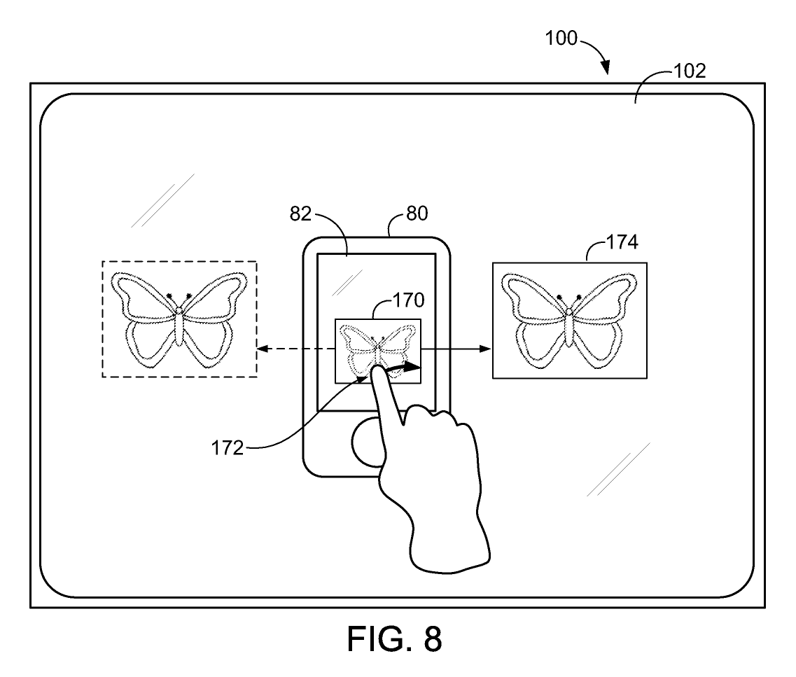

FIG. 8 provides another example of cross-device gesture-based interaction between devices 80 and 100. In this example, a touch gesture applied at device 80 is spatially interpreted to control output on display 102. Specifically, a flicking gesture 172 is applied to an image item 170 on display screen 82. The gesture causes a corresponding representation 174 of the image item to be displayed on display 102. The location of corresponding representation 174 is based upon a direction of the flicking gesture 172. In particular, a rightward gesture causes the corresponding representation to appear to the right side of device 80, while a leftward flicking gesture causes it to appear to the left side (indicated in dashed outline).

Referring again to FIG. 2, the example of FIG. 8 will be described in terms of how various components in FIG. 2 may interact to achieve the cross-device interaction. As in certain previous examples, the relative position and/or orientation of device 80 and device 100 may be determined using optic subsystem 104. Accordingly, spatial module 108 may be provided with a spatial context which specifies the relative locations of the devices. The spatial information may be shared by corresponding spatial modules on the interacting devices (e.g., spatial module 108 and spatial module 86).

The flicking gesture at display screen 82 produces a gesture input at gesture interpretation module 88. The gesture has a direction in terms of device 80, for example the gesture may be a touchscreen flick towards a particular edge of device 80. Because the relative position/orientation of the devices is known via the spatial context, the gesture can be interpreted at gesture interpretation module 88 and/or gesture interpretation module 110 to provide spatial meaning to the gesture. In other words, display output on table-type computing device 100 can be controlled in response to the direction of touch gestures applied at device 80.

In many examples, it can be advantageous to provide all interacting devices with the described spatial and gesture interpretation modules. This may allow for efficient sharing of spatial information and interpretation of gesture inputs at each device. For example, even if only one interacting device has position-sensing capability, the spatial information it detects can be provided to other devices. This sharing would allow the other devices to use the spatial information for gesture interpretation.

It will be appreciated that the example of FIG. 8 may occur in reverse. In particular, the initial image item may be displayed on large-format horizontally-oriented display 102. A dragging, flicking, etc. type gesture may be applied to the image item, and depending on the direction of that gesture, it would cause a corresponding image to appear on display screen 82 of device 80. Furthermore, the velocity of the gesture, if sufficiently high, could cause a brief overlay view of the image to appear and move across screen 82, with the image item eventually coming to rest on portion of display on the opposite side of device 80.

In a further example, table-type computing device 100 could act as a broker between two portable devices placed on the surface of display 102. In this example, all three devices could employ spatial gesture interpretation. Accordingly, a flick gesture at one portable device could transfer a digital photograph to be displayed on the table-type computing device, or on the other portable device, depending on the direction of the gesture and the spatial context of the three interacting devices.

In yet another example, the portable device in FIG. 8 can be tilted to initiate an image transfer and control display of the corresponding image on table-type computing device 100. In such a case, a gesture interpretation module on the portable device would detect the tilting of the device. The corresponding spatial interpretation modules would have awareness of the relative position of the portable device and the table-type device. Accordingly, the tilting of the portable device in a particular direction can cause a transferred image to be placed in a particular location on the display of the table-type device. Furthermore, in this example, a visual effect can be employed to simulate a gradual pouring or sliding of an image off of the portable device and onto the table-type device.

The above example, in which an image is “poured” off of one display and onto another, may involve an image being partially displayed on multiple devices. This “overlapping” of images, in which an image overlaps multiple devices with part of the image being displayed on each of the devices, may also be employed in connection with various of the other examples discussed in the present disclosure. Overlapping may be employed, for example, in image editing operations. A gesture might be employed to slowly slide an image off to a destination, where the image is to be clipped and stitched into a composite view. Alternatively, cropping could be employed at the source device, with only the desired portion of the image being transferred via an overlapping or other visual representation of the transfer.

Gestures applied at multiple devices may also be interpreted in a combined fashion. At each of two separate devices, a gesture is applied to cause a gesture input to be received at a gesture interpretation module of the device. The corresponding gesture modules then communicate wirelessly, and a combined interpretation of the two gestures may be used to drive display output or provide other functionality at one or both of the devices.

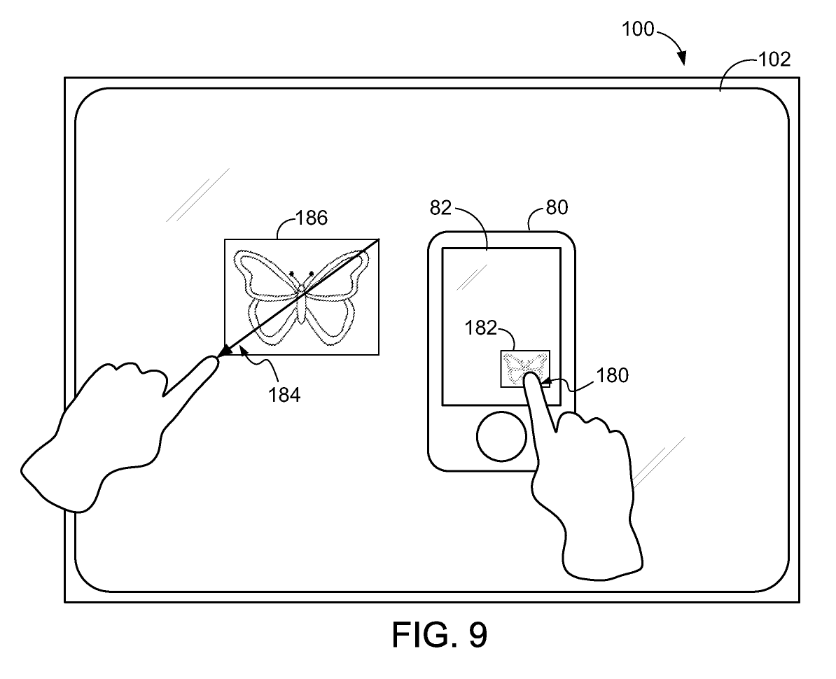

FIG. 9 shows an example of a combined interpretation of a touch gesture applied at portable computing device 80 and a touch gesture applied at table-type computing device 100. In particular, a select gesture 180 is applied to display screen 82 to select a particular digital photograph 182. At device 100, a dragging expansion gesture 184 is applied to display 102. The gesture interpretation modules of the devices provide a combined interpretation of the two different gestures, in which the photograph is transferred to device 100 and its corresponding representation 186 is sized based on the dimensions of expansion gesture 184. This is but one example; a wide variety of other combined gestures may be employed to control display output and provide other functionality.

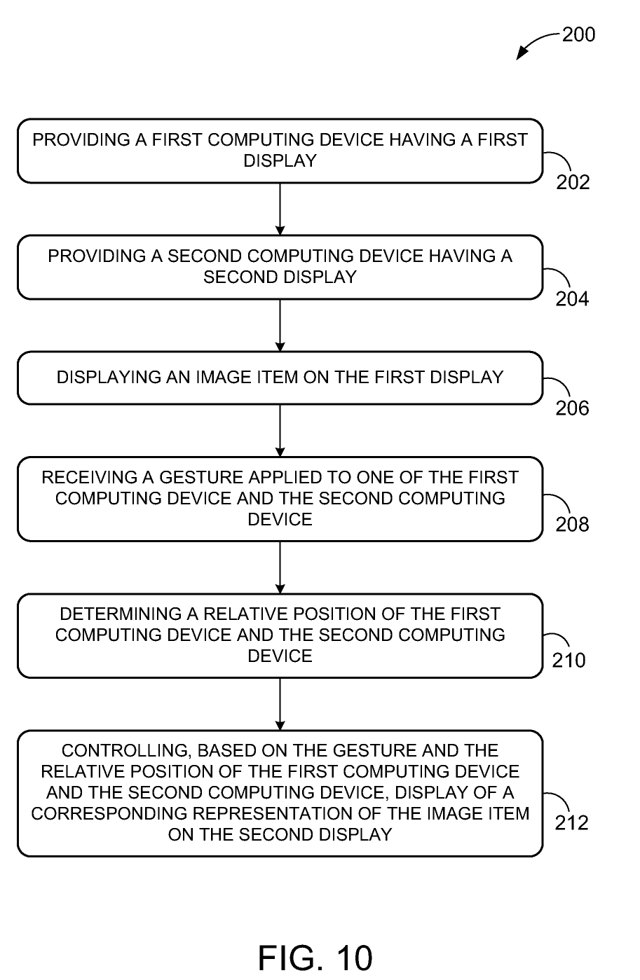

FIG. 10 depicts an exemplary method 200 for providing cross-device gesture interaction. The exemplary method depicts steps occurring in a particular order, though it will be appreciated that the steps may be performed in a different order, and/or certain steps may be performed simultaneously. As shown at step 202, the method may include providing a first computing device having a first display. As shown at step 204, the method may include providing a second computing device having a second display. As shown at step 206, the method may include displaying an image item on the first display.

As shown at step 208, the method may include receiving a gesture applied to one of the first computing device and the second computing device. As shown at step 210, the method may include determining a relative position of the first computing device and the second computing device. As shown at step 212, the method may include controlling, based on the gesture and the relative position of the first computing device and the second computing device, display of a corresponding representation of the image item on the second display.

As in the above examples, the initial image item and the corresponding representation that is controlled at the other device may take various forms. The gesture may cause, for example, a photograph on the first display to be displayed in similar or modified form on the second display. A direction of the gesture may be interpreted to control a display location on the target device, as in the example of FIG. 8. Overlay orientations and corresponding gestures may be employed, such as in the examples of FIG. 6 and FIG. 7. In addition a combined gesture interpretation may be employed, as in the example of FIG. 9.

The spatial and gesture interpretation modules discussed herein may be implemented in various ways. In one example, spatial and gesture functionality is incorporated into a specific application that supports cross-device gesturing. In another example, the gesture and/or spatial functionality is part of the computing device platform (e.g., the spatial modules and gesture interpretation modules can be built into the operating system of the device). Another alternative is to provide an exposed interface (e.g., an API) which incorporates spatial and gesture interpretation modules that are responsive to pre-determined commands.

Many of the examples discussed herein involve transfer of an image item from one device to another and/or controlling the display of an image item on one device based on a gesture applied at another device. It should be understood that these image items can represent a wide variety of underlying items and item types, including photographs and other images, contact cards, music, geocodes, etc., to name but a few additional examples.

Referring again to various components of FIG. 1, it should be understood that a logic subsystem (e.g., logic subsystem 28a or logic subsystem 28b) may include one or more physical devices configured to execute one or more instructions. For example, the logic subsystem may be configured to execute one or more instructions that are part of one or more programs, routines, objects, components, data structures, or other logical constructs. Such instructions may be implemented to perform a task, implement a data type, transform the state of one or more devices, or otherwise arrive at a desired result. The logic subsystem may include one or more processors that are configured to execute software instructions, such as to carry out the cross-device gesture functionality provided by the spatial and gesture modules described herein. Additionally or alternatively, the logic subsystem may include one or more hardware or firmware logic machines configured to execute hardware or firmware instructions. The logic subsystem may optionally include individual components that are distributed throughout two or more devices, which may be remotely located in some embodiments.

When employed in the above examples, a storage subsystem may include one or more physical devices configured to hold data and/or instructions executable by a logic subsystem to implement the herein described methods and processes. When such methods and processes are implemented, the state of the storage subsystem may be transformed (e.g., to hold different data). The storage subsystem may include removable media and/or built-in devices. The storage subsystem may include optical memory devices, semiconductor memory devices, and/or magnetic memory devices, among others. The storage subsystem may include devices with one or more of the following characteristics: volatile, nonvolatile, dynamic, static, read/write, read-only, random access, sequential access, location addressable, file addressable, and content addressable. In some embodiments, a logic subsystem and storage subsystem may be integrated into one or more common devices, such as an application specific integrated circuit or a system on a chip.

When included in the above examples, a display subsystem may be used to present a visual representation of data held by a storage subsystem. As the herein described methods and processes change the data held by the storage subsystem, and thus transform the state of the storage subsystem, the state of the display subsystem may likewise be transformed to visually represent changes in the underlying data. The display subsystem may include one or more display devices utilizing virtually any type of technology. Such display devices may be combined with a logic subsystem and/or a storage subsystem in a shared enclosure, or such display devices may be peripheral display devices.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A system for providing cross-device gesture-based interactivity, comprising:
a first computing device with a first display operative to display an image item;
a second computing device with a second display operative to display a corresponding representation of the image item;
a spatial module on one of the first computing device and the second computing device and operative to receive a spatial context based on a relative position of the first computing device and the second computing device;
a gesture interpretation module on one of the first computing device and the second computing device and operative to receive a gesture input and output a cross-device display command which is dependent upon the gesture input and the spatial context, the cross-device display command being wirelessly communicated between the first computing device and the second computing device and operative to control display of the corresponding representation of the image item.

2. The system of claim 1, wherein the cross-device display command is based on a touch gesture applied to the image item at the first display.

3. The system of claim 2, wherein the touch gesture causes the image item to be wirelessly transferred to the second computing device and causes the corresponding representation of the image item to be displayed at a location on the second display, the location being dependent upon a direction of the touch gesture and the relative position of the first computing device and the second computing device.

4. The system of claim 1, wherein the cross-device display command is based on a joining gesture, in which the first computing device and the second computing device are brought together in close proximity.

5. The system of claim 4, wherein when the joining gesture causes the first display and the second display to be in an overlay orientation, the cross-device display command is operative to cause the corresponding representation of the image item to provide an overlay representation of the image item.

6. The system of claim 1, wherein the cross-device display command is based on a separating gesture, in which the first computing device and the second computing device are separated from a state of being in close proximity to each other.

7. The system of claim 6, wherein the separating gesture causes the image item to be wirelessly transferred to the second computing device and causes the second display to display the corresponding representation of the image item.

8. The system of claim 1, wherein the cross-device display command is based on a stamping gesture, in which the first computing device and the second computing device are brought together to, and then separated from, a state of being in close proximity to each other.

9. The system of claim 8, wherein the stamping gesture causes the image item to be wirelessly transferred to the second computing device and causes the second display to display the corresponding representation of the image item.

10. The system of claim 1, wherein one of the first computing device and the second computing device includes a touch interactive display and an optical subsystem operatively coupled with the touch interactive display.

11. The system of claim 10, wherein the optical subsystem is operatively coupled with the spatial module and is configured to optically determine the spatial context.

12. A system for providing cross-device gesture-based interactivity, comprising:
a first computing device, including a first touchscreen interactive display and a first gesture interpretation module, the first gesture interpretation module being operable to receive a gesture input based on a touch gesture applied to the first touchscreen interactive display, and output a cross-device gesture command based on the gesture input for wireless transmission by the first computing device;
a second computing device in spatial proximity with the first computing device and operative to wirelessly receive the cross-device gesture command, the second computing device including a second touchscreen interactive display and a second gesture interpretation module, the second gesture interpretation module operative to receive the cross-device gesture command and output a display command based on the cross-device gesture command, wherein the display command controls a visual output on the second touchscreen interactive display.

13. The system of claim 12, wherein the second gesture interpretation module is operative to receive a gesture input based on a touch gesture applied to the second touchscreen interactive display, and operative to cause the visual output to be controlled based on a combined interpretation of the touch gesture applied to the first touchscreen interactive display and the touch gesture applied to the second touchscreen interactive display.

14. The system of claim 12, wherein the cross-device gesture command is operative to cause wireless transmission of an image item from the first computing device to the second computing device, and wherein the visual output includes a representation of the image item.

15. The system of claim 14, wherein the representation of the image item is displayed at a location on the second touchscreen interactive display, the location being dependent upon a direction of the touch gesture applied to the first touchscreen interactive display.

16. The system of claim 12, further comprising a spatial module on one of the first computing device and the second computing device, the spatial module being operative to receive a spatial context which is based on a relative position of the first computing device and the second computing device, wherein the visual output on the second touchscreen interactive display is dependent upon the spatial context.

17. A method of providing cross-device gesture interaction among multiple computing devices, comprising:
providing a first computing device having a first display;
providing a second computing device having a second display;
displaying an image item on the first display;
receiving a gesture applied to one of the first computing device and the second computing device;
determining a relative position of the first computing device and the second computing device; and
controlling, based on the gesture and the relative position of the first computing device and the second computing device, display of a corresponding representation of the image item on the second display.

18. The method of claim 17, wherein controlling display of a corresponding representation of the image item on the second display includes controlling a location on the second display of the corresponding representation of the image item.

19. The method of claim 18, wherein the location is controlled based on a direction of the gesture.

20. The method of claim 17, wherein controlling display of a corresponding representation of the image item on the second display includes providing, in response to the first display and the second display being placed in an overlay orientation, an overlay representation of the image item on the second display.
